(19) United States
(12) Patent Application Publication
(10) Pub. No.: US 2015/0054467 A1
(43) Pub. Date: Feb. 26, 2015

(54) BATTERY CONTROL DEVICE

(71) Applicant: SANYO ELECTRIC CO., LTD., Osaka (JP)

(72) Inventors: Kyoichi Takano, Osaka (JP); Takeshi Nakashima, Osaka (JP)

(21) Appl. No.: 14/388,599

(22) PCT Filed: Mar. 14, 2013
(86) PCT No.: PCT/JP2013/057121

§ 371 Date: Sep. 26, 2014

(30) Foreign Application Priority Data
Mar. 28, 2012 (JP) 2012-073479

(51) Int. Cl. H02J 7/00; H02J 7/34

(52) U.S. Cl. CPC H02J 7/0031; H02J 7/34; H02J 7/0047; H02J 7/0068; H02J 2007/005
USPC 320/136

(57) ABSTRACT

A battery management portion has communication portions for receiving battery status data from a battery unit and transmitting a signal based on the battery status data (e.g., a signal pertaining to allowing or disallowing charging and discharging) to a power conversion control portion which performs charge/discharge control. Operation is performed in either a normal operation mode, in which communication is continuously performed by the communication portions, or an intermittent operation mode, in which communication by the communication portions is intermittently discontinued, according to the mode request signal from the control portion. If an abnormal state (such as overcharging) is identified during operation in the intermittent operation mode, the operation mode is forcibly shifted to the normal operation mode, irrespective of the state and content of reception of the mode request signal.

### TECHNICAL FIELD

The present invention relates to a battery control device.

### BACKGROUND ART

As shown in FIG. 16A, between a power block 901 that outputs electric power and a power block 902 that receives electric power, a power controller 903 that includes a power conversion circuit and a power conversion controller is interposed in a system 900 (such as a solar cell system) that is in practical use. In an attempt to add a power storage function to this type of system 900, as shown in FIG. 16B, a battery unit 904 comprising a secondary battery can be connected to the power controller 903. A technology is also proposed whereby a hierarchically higher system controller performs charge/discharge control while communicating with a block that manages a battery pack (see Patent Document 1 identified below).

### LIST OF CITATIONS

### Patent Literature

Patent Document 1: JP A-2011-205827

### SUMMARY OF THE INVENTION

### Technical Problem

In a system as shown in FIG. 16B, to ensure the safety of the battery unit 904, communication for acquiring the battery status (the current value, temperature, etc. of the battery) should be conducted to monitor the battery status. No less important is power saving. In this respect, through control involving intermittent suspension of communication for battery status monitoring, power saving can be achieved. Where a battery manager is provided between, for mediation between, the power controller 903 and the battery unit 904, instructions related to intermittent suspension of communication are often transmitted from the hierarchically higher power controller 903 to the battery manager. Heeding instructions from a hierarchically higher system all the time, however, is not necessarily optimal. Compulsorily performed according to instructions from the hierarchically higher side, intermittent suspension of communication may jeopardize the safety of the battery unit 904 and cause other inconveniences.

Against the background discussed above, an object of the present invention is to provide a battery control device that can achieve power saving while ensuring safety.

### Means for Solving the Problem

According to one aspect of the present invention, a battery control device which monitors charge/discharge control, by a charge/discharge control portion, of a battery unit including a secondary battery in order to protect the battery unit is provided with: a communication portion which communicates with each of the battery unit and the charge/discharge control portion; and a control portion which sets as a target operation mode either a normal operation mode in which communication is conducted continuously in the communication portion or an intermittent operation mode in which communication is suspended intermittently in the communication portion, the control portion executing communication in the communication portion according to the target operation mode. Here, while the target operation mode is the intermittent operation mode, when a predetermined cancellation condition is fulfilled, the control portion switches the target operation mode from the intermittent operation mode to the normal operation mode.

### Advantageous Effects of the Invention

According to the present invention, it is possible to provide a battery control device that can achieve power saving while ensuring safety.

### BRIEF DESCRIPTION OF DRAWINGS

FIG. 1 is an outline overall configuration diagram of an electric power system embodying the present invention;

FIG. 2 is an internal configuration diagram of one battery unit;

FIG. 3 is a diagram showing a structure of battery status data;

FIG. 4 is a diagram showing an example of connection of a plurality of battery units in one embodiment of the present invention;

FIG. 5 is a diagram showing an example of an internal configuration of a battery management portion and a breaker portion in one embodiment of the present invention;

FIG. 6 is a diagram showing an example of a procedure of communication via a battery management portion;

FIG. 7 is a diagram illustrating the contents of a response signal from a battery management portion to a power conversion control portion;

FIGS. 8A and 8D are diagrams illustrating a mode request signal, FIGS. 8B and 8E are diagrams illustrating a mode notification signal, and FIG. 8C is a diagram showing an operation mode setting portion;

FIG. 9 is a diagram showing alternation of active periods and sleep periods in intermittent operation mode;

FIG. 10 is a diagram showing switching between normal operation and intermittent operation;

FIG. 11 is a diagram showing an outline of signal exchange related to inhibition of switching to intermittent operation, in connection with a second application example of intermittent operation;

FIGS. 12A and 12B are diagrams showing software held in a main control portion and in a unit control portion respectively;

FIG. 13 is a flow chart of the operation of a battery management portion, in connection with the second application example of intermittent operation;

FIG. 14 is a diagram showing an outline of signal exchange related to forcible returning to normal operation, in connection with a third application example of intermittent operation;

FIG. 15 is a flow chart of the operation of a battery management portion, in connection with the third application example of intermittent operation; and

FIGS. 16A and 16B are outline block diagrams of conventional systems for power conversion.

### DESCRIPTION OF EMBODIMENTS

Hereinafter, exemplary embodiments of the present invention will be described specifically with reference to the accompanying drawings. Among different drawings referred to, the same parts are identified by the same reference signs, and in principle no overlapping description of the same parts will be repeated. In the present specification, for simplicity's sake, symbols and signs referring to information, signals, physical quantities, states, members, etc. are occasionally used with the names of the corresponding information, signals, physical quantities, states, members, etc. omitted or abbreviated.

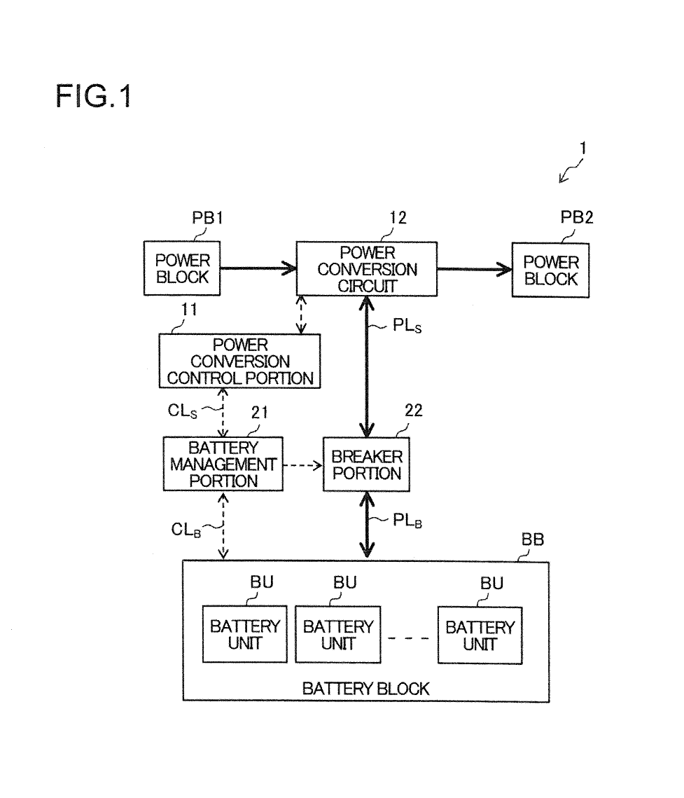

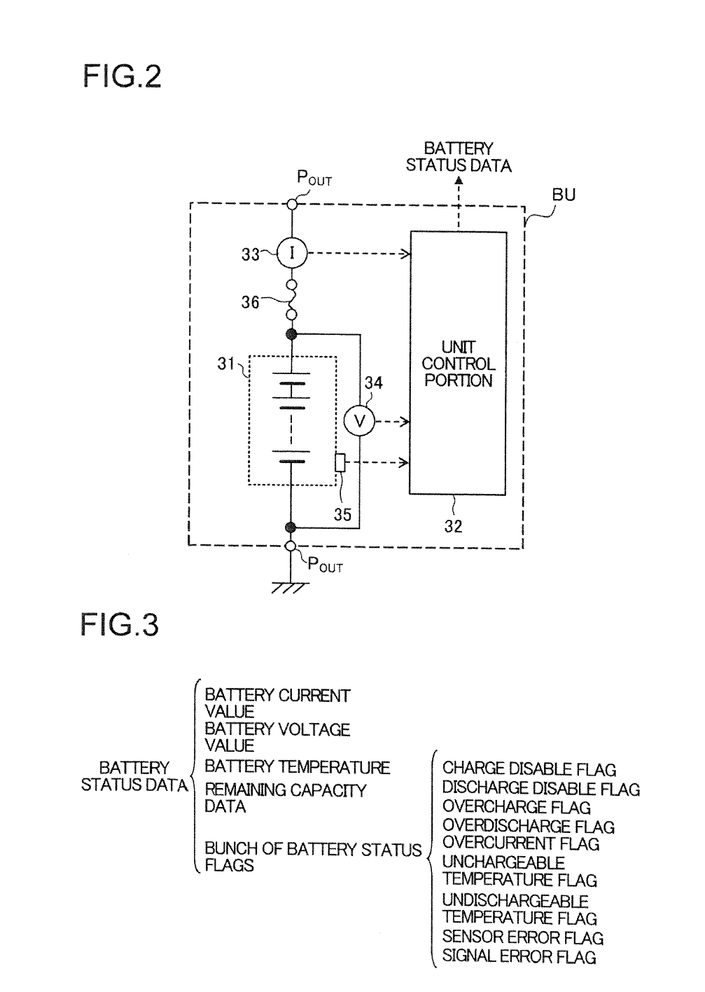

FIG. 1 is an outline overall configuration diagram of an electric power system 1 embodying the present invention. The electric power system 1 includes a power conversion control portion 11, a power conversion circuit 12, a battery management portion 21, a breaker portion 22, a battery block BB comprising one or more battery units BU, a power block PB1 for output of electric power, and a power block PB2 for reception of electric power. The power blocks PB1 and PB2 are connected to the power conversion circuit 12. Any number, one or more, of power blocks can be connected to the power conversion circuit 12; thus, a single power block can bidirectionally handle input and output of electric power from and to the power conversion circuit 12. FIG. 2 is an internal configuration diagram of one battery unit BU. Each battery unit BU includes a battery module 31 comprising secondary cells. In this embodiment, charging and discharging refers to, unless otherwise stated, the charging and discharging of the battery module 31 (more specifically, the charging and discharging of the secondary cells in the battery module 31). Accordingly, for example, discussing the charging and discharging of the battery unit BU is tantamount to discussing the charging and discharging of the battery module 31.

The power conversion circuit 12 includes a plurality of switching devices comprising field-effect transistors, insulated-gate bipolar transistors, or the like, and executes power conversion operation under the control of the power conversion control portion 11. The power conversion operation includes charge operation and discharge operation.

In charge operation, the power conversion circuit 12 converts the output electric power of the power block PB1 into desired direct-current electric power, and supplies the obtained direct-current electric power via the breaker portion 22 to each battery unit BU. The power block PB1 is an electric power source that outputs either alternating-current electric power or direct-current electric power, and includes, for example, a commercial alternating-current electric power source or a solar cell unit. Each battery unit BU is charged when receiving direct-current electric power based on the output electric power of the power block PB1.

In discharge operation, the power conversion circuit 12 receives the discharge electric power from each battery unit BU via the breaker portion 22, and converts the received discharge electric power into desired direct-current electric power or alternating-current electric power to feed it to the power block PB2. The power block PB2 is, for example, a load that consumes electric power, and is driven by the output electric power from the power conversion circuit 12. The power conversion circuit 12 can also feed the output electric power of the power block PB1 to the power block PB2 directly without passage through a battery unit BU (in that case, predetermined power conversion can be performed).

The power conversion control portion 11 controls the operation, including power conversion operation, of the power conversion circuit 12. The power conversion control portion 11 can thus be said to include a charge/discharge control portion for controlling the charging and discharging of the battery units BU.

The battery management portion 21 communicates with each battery unit BU across a communication line CL_{B}, and communicates with the power conversion control portion 11 across a communication line CL_{S}. The battery management portion 21 receives, from each battery unit BU, battery status data (see FIG. 2) indicating the status of the battery module 31 inside the battery unit BU, and converts the respective received battery status data into a data format for the power conversion control portion 11 to transmit it to the power conversion control portion 11 (the battery status data will be described in detail later).

The breaker portion 22 comprises a breaker (current breaker) interposed between, in series with, the battery module 31 of each battery unit BU and the power conversion circuit 12, and is either in an on state or in an off state at a time. When the breaker portion 22 is on, each battery module 31 is connected to the power conversion circuit 12, so that each battery module 31 can be charged and discharged via the power conversion circuit 12. When the breaker portion 22 is off, the electric path between each battery module 31 and the power conversion circuit 12 is disconnected, so that no battery module 31 can be charged or discharged via the power conversion circuit 12. Instead of a breaker, any other component, such as a self-control protector (SCP) or a mechanical relay, that can disconnect the above-mentioned electric path according to a signal from outside can be used to build the breaker portion 22. The electric path between each battery module 31 and the power conversion circuit 12 comprises a power line PL_{B}, which is an electric path between each battery module 31 and the breaker portion 22, and a power line PL_{S}, which is an electric path between the power conversion circuit 12 and the breaker portion 22. The breaker portion 22 is in principle kept on, and accordingly, in this embodiment, unless otherwise stated, it is assumed that the breaker portion 22 is kept on.

With reference to FIG. 2, the configuration of one battery unit BU will be described. The battery unit BU includes components referred to by the reference signs 31 to 36. A battery module 31 comprises one or more secondary cells (secondary batteries). The secondary cells constituting the battery module 31 can be of any type, examples including lithium-ion cells and nickel-hydride cells. The battery module 31 can comprise a single secondary cell; in this embodiment, however, it is assumed that the battery module 31 comprises a plurality of secondary cells connected in series. Part or all of the secondary cells constituting the battery module 31 can be a plurality of secondary cells connected in parallel. Among a plurality of secondary cells connected in series in the battery module 31, the positive electrode of the secondary cell located at the highest-potential end and the negative electrode of the secondary cell located at the lowest-potential end are connected to a pair of power input/output terminals P_{OUT} of the battery unit BU, so that via the pair of power input/output terminals P_{OUT}, the battery module 31 is charged and discharged.

Between the battery module 31 and the pair of power input/output terminals P_{OUT}, there are interposed, in series, a current sensor 33, for measuring the value (hereinafter referred to as the battery current value) of the current passing through the battery module 31, and a fuse 36 such as a self-control protector. Across both terminals of the battery module 31, a voltage sensor 34 is connected in parallel. The voltage sensor 34 measures the value (hereinafter referred to as the battery voltage value) of the voltage across the battery module 31. The battery voltage value is the terminal voltage value of the battery module 31, that is, the value of the potential difference between the positive electrode of the secondary cell located at the highest-potential end and the negative electrode of the secondary cell located at the lowest-potential end in the battery module 31. The potential difference between the positive and negative electrodes of each secondary cell in the battery module 31 (that is, the voltage value for each cell in the battery module 31) can also be measured to be included in the battery status data. The battery module 31 is provided with a temperature sensor 35. The temperature sensor 35 measures the temperature (hereinafter referred to as the battery temperature) of the battery module 31. The battery temperature is, for example, the surface temperature of the pack enclosing the plurality of secondary cells in the battery module 31, or the temperature at a particular spot in the battery module 31.

The battery current value, battery voltage value, and battery temperature measured by the sensors 33, 34, and 35 are fed to a unit control portion 32. The unit control portion 32 generates battery status data (battery status information) based on the measured battery current value, battery voltage value, and battery temperature, and transmits it to the battery management portion 21. For each battery unit BU, such battery status data is generated and transmitted to the battery management portion 21.

FIG. 3 is a diagram showing the structure of battery status data transmitted from one battery unit BU. The battery status data in FIG. 3 is an example of the status data of the battery module 31 (data indicating the status of the battery module 31), and includes, on one hand, information indicating the battery current value, battery voltage value, and battery temperature and, on the other hand, as information derivable from the battery current value and battery voltage value, remaining capacity data indicating the remaining capacity or SOC (state of charge) of the battery module 31 and a bunch of battery status flags comprising a plurality of flags. The bunch of battery status flags can include a charge disable flag indicating whether or not to disable the charging of the battery module 31, a discharge disable flag indicating whether or not to disable the discharging of the battery module 31, an overcharge flag indicating whether or not the battery module 31 is in an overcharged state, an overdischarge flag indicating whether or not the battery module 31 is in an overdischarged state, an overcurrent flag indicating whether or not the battery module 31 is in an overcurrent state, an unchargeable temperature flag indicating whether or not the battery temperature is unfit for charging, an undischargeable temperature flag indicating whether or not the battery temperature is unfit for discharging, a sensor error flag indicating whether or not any of the sensors 33, 34, and 35 is faulty, and a signal error flag indicating whether or not a communication fault is present. Each flag in the bunch of battery status flags has a digital value (logical value) of either 1 or 0 at a time.

Each flag in the bunch of battery status flags has an initial value of 0. For convenience' sake, operation for substituting a value of 0 or 1 in the flags in the bunch of battery status flags is referred to as flag setting operation. In each battery unit BU, the unit control portion 32 performs flag setting operation on each flag in the bunch of battery status flags based on the battery current value, battery voltage value, and battery temperature from the sensors 33, 34, and 35. The flag setting operation on the flags in the bunch of battery status flags can instead be performed by the battery management portion 21. In that case, based on the battery current value, battery voltage value, and battery temperature in the battery status data from a given battery unit BU, the battery management portion 21 can perform flag setting operation on each flag in the bunch of battery status flags for that battery unit BU.

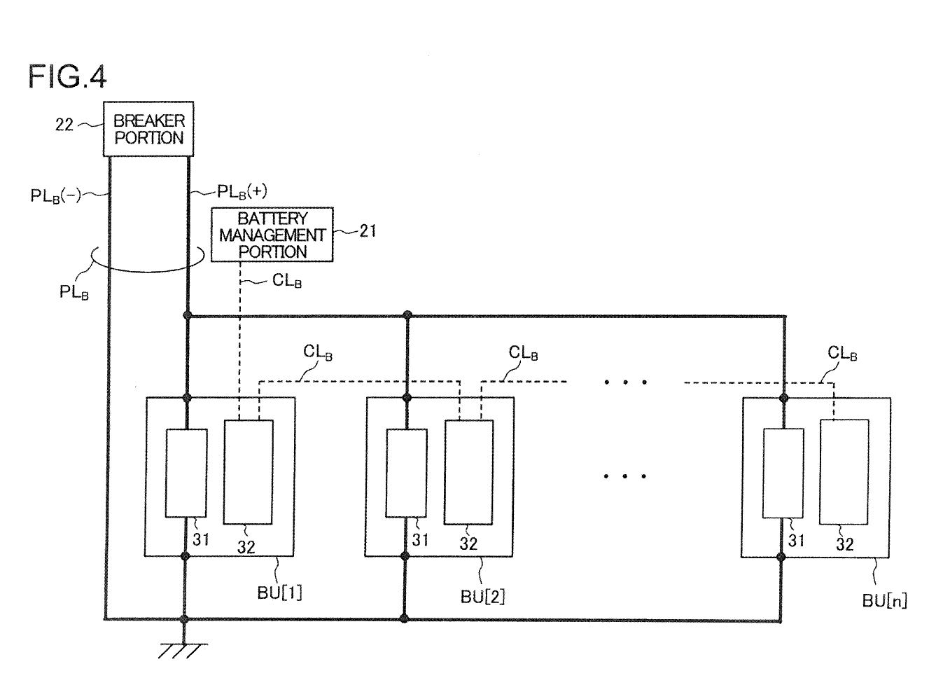

In a case where the battery block BB comprises a plurality of battery units BU, the plurality of battery units BU can be connected together in any way. The following description, however, assumes the following configuration: as shown in FIG. 4, the battery block BB includes n battery units BU (hereinafter also referred to as the battery units BU[1] to BU[n]), and the n battery units BU are connected in parallel with one another via the power line PL_{B}, so that a parallel connection circuit comprising n battery modules 31 is connected via the breaker portion 22 to the power conversion circuit 12. Here, n is an integer of two or more. In FIG. 4, the current sensor 33 and the like are omitted from illustration. The power line PL_{B} comprises a power line PL_{B}(+) to which the positive-side power input/output terminal P_{OUT} of each battery unit BU is commonly connected and a power line PL_{B}(−) to which the negative-side power input/output terminal P_{OUT} of each battery unit BU is commonly connected. This, however, is not meant to limit how the n battery units BU are connected together via the power line PL_{B}; a serial connection circuit comprising a plurality of battery modules 31 can be included in the battery block BB.

The battery management portion 21 is connected to each unit control portion 32 via the communication line CL_{B}. Here, a total of n unit control portions 32 in the battery units BU[1] to BU[n] are preferably connected together in a daisy-chain configuration or the like and then to the battery management portion 21. Adopting this configuration makes it possible to handle the battery status of the plurality of battery units BU constituting the battery block BB as a bunch of battery statuses, and this makes more accurate control possible. However, the battery block BB can instead be so configured that the plurality of unit control portions 32 are integrated into a single unit. In that case, even when a plurality of battery units BU are used, the battery management portion 21 has only to handle a single target of communication, and this advantageously helps simplify the control.

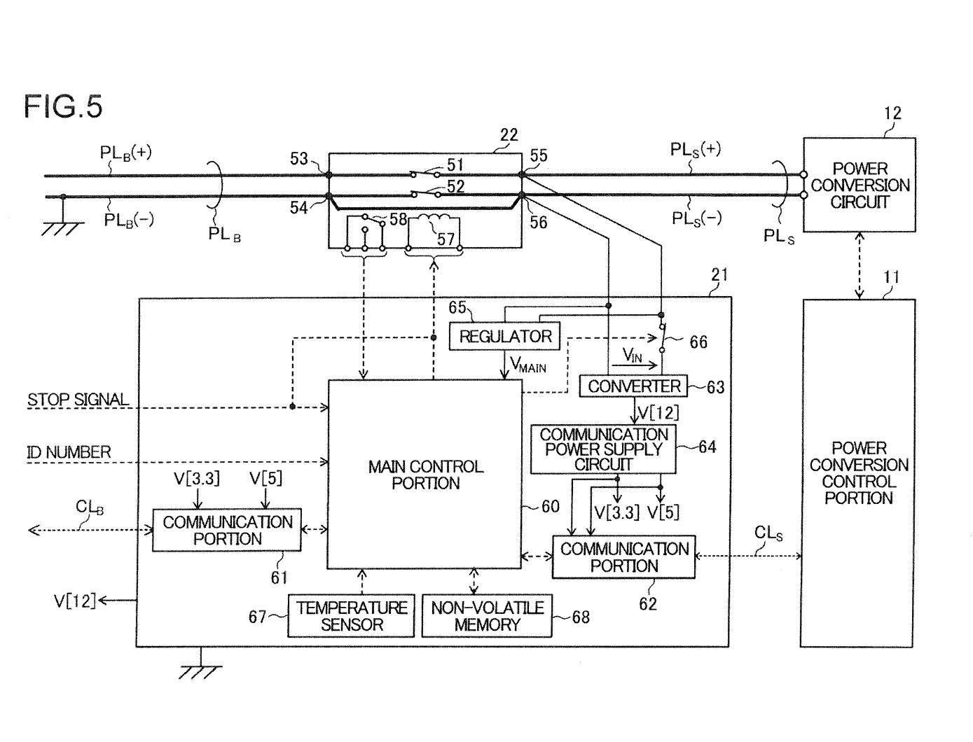

FIG. 5 shows an example of an internal configuration of the battery management portion 21 and the breaker portion 22. The breaker portion 22 includes components referred to by the reference signs 51 to 58. The battery management portion 21 includes components referred to by the reference signs 60 to 68.

The power line PL_{S} comprises a high-potential-side power line PL_{S}(₊) and a low-potential-side power line PL_{S}(−). The power lines PL_{B}(+), PL_{B}(−), PL_{S}(+), and PL_{S}(−) are connected to breaker terminals 53, 54, 55, and 56, respectively. Between the breaker terminals 53 and 55, a breaker switch 51 is interposed in series, and between the breaker terminals 54 and 56, a breaker switch 52 is interposed in series. A state where the breaker portion 22 is on is a state where the breaker switches 51 and 52 are on and hence the power lines PL_{B} and PL_{S} are connected together. A state where the breaker portion 22 is off is a state where the breaker switches 51 and 52 are off and hence the power lines PL_{B} and PL_{S} are disconnected from each other. A main control portion 60 can, under a predetermined condition, apply a voltage V[12] (described later) to a coil 57 via an unillustrated breaker trip circuit to turn off the breaker switches 51 and 52. On the other hand, the unit control portion 32 of each battery unit BU can, when a fault (such as overcharging) occurs and it is serious, output a STOP signal, and also when this STOP signal is output, the breaker portion 22 is turned off. By referring to the state of a three-terminal switch 58 of which the state changes in coordination with the breaker switches 51 and 52 being turned on and off, the main control portion 60 can recognize the on/off state of the breaker portion 22. The breaker switch 52 can be omitted, in which case the breaker terminals 54 and 56 can be connected together directly without passage through a breaker switch 52.

The power line PL_{S} is connected, via the breaker terminals 55 and 56 and a switch 66 comprising a field-effect transistor or the like, to a converter 63. The on/off state of the switch 66 is controlled by the main control portion 60. When the switch 66 is on, the voltage between the terminals 55 and 56 is, as an input voltage V_{IN}, applied to the converter 63. When the switch 66 is off, the voltage between the terminals 55 and 56 is not supplied to the converter 63 (thus, V_{IN}=0). When the breaker portion 22 and the switch 66 are both on, the converter 63 converts the input voltage V_{IN} into a voltage V[12] having a predetermined voltage value (for example, 12 volts DC) and outputs it to a communication power supply circuit 64. The communication power supply circuit 64 converts the voltage V[12] into communication supply voltages and outputs them to communication portions 61 and 62. The communication portions 61 and 62 are driven by, as their driving voltages, the communication supply voltages. In the example shown in FIG. 5, the communication supply voltages comprise a supply voltage V[3.3] having a predetermined first voltage value (for example, 3.3 volts DC) and a supply voltage V[5] having a predetermined second voltage value (for example, 5 volts DC). A regulator 65 is connected to the power line PL_{S} (that is, the breaker terminals 55 and 56) directly without passage through the switch 66, and generates from the voltage between the breaker terminals 55 and 56 a voltage V_{MAIN} having a desired voltage value (for example, 5 V DC).

The main control portion 60 comprises a CPU (central processing unit) or the like, and is driven by, as its driving voltage, the voltage V_{MAIN}. The main control portion 60 controls the operation of the communication portions 61 and 62 for communication, and controls operation within the battery management portion 21 in a centralized fashion. The communication portion 61 communicates with each battery unit BU (that is, each unit control portion 32) connected thereto via the communication line CL_{B}. The communication portion 62 communicates with the power conversion control portion 11 connected thereto via the communication line CL_{S}. From each battery unit BU, the main control portion 60 is previously notified of an ID number unique to the battery unit BU, so that the communication portion 61 can communicate with a desired battery unit BU with the help of its ID number. The battery management portion 21 supplies each battery unit BU with the output voltage V[12] of the converter 63 for the driving of the unit control portion 32 of the battery unit BU.

A temperature sensor 67 measures the temperature at a predetermined spot in the battery management portion 21 (for example, the temperature of the circuit board on which the main control portion 60 is mounted, or the surface temperature of the housing of the battery management portion 21), and conveys the measured temperature to the main control portion 60. A non-volatile memory 68 comprises an EEPROM (electrically erasable programmable read-only memory) or the like.

### Communication

The communication by the communication portion 61 (that is, the communication between the battery management portion 21 and any battery unit BU) and the communication by the communication portion 62 (that is, the communication between the battery management portion 21 and the power conversion control portion 11) can each be full-duplex communication independent of the other. In this embodiment, it is assumed that they are each half-duplex communication independent of the other. Under the control of the main control portion 60, half-duplex communication by the communication portion 61 and half-duplex communication by the communication portion 62 are conducted independently of each other. As is well known, when half-duplex communication is conducted between two blocks, not both blocks can transmit or receive simultaneously; while one block is transmitting a signal, the other block has to receive the signal. The half-duplex communication by the communication portions 61 and 62 can be conducted, for example, in compliance with the RS-485 communication standard. In the half-duplex communication by the communication portions 61 and 62, a master-slave method is adopted. Specifically, in the communication by the communication portion 61, the battery management portion 21 (that is, the communication portion 61) is designated as a master, and any battery unit BU (that is, the unit control portions 32) is designated as a slave. On the other hand, in the communication by the communication portion 62, the power conversion control portion 11 is designated as a master, and the battery management portion 21 (that is, the communication portion 62) is designated as a slave.

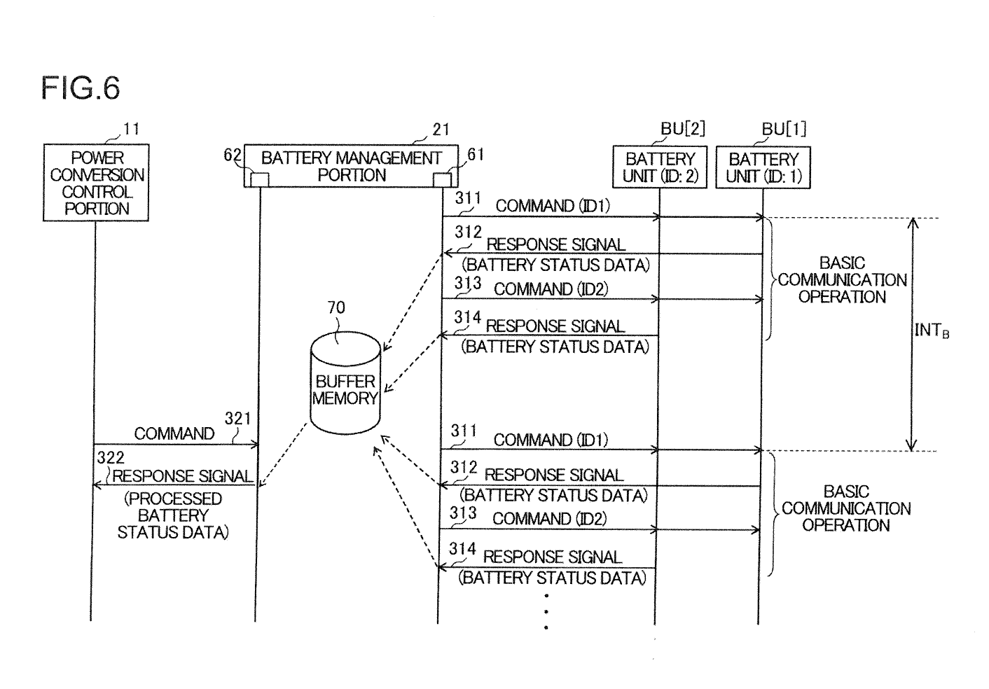

With reference to FIG. 6, an example of a procedure for communication by the communication portions 61 and 62 will be described. In FIG. 6, the direction from top down corresponds to the lapse of time. In the following description of a communication procedure with reference to FIG. 6, for the sake of concreteness, it is assumed that two battery units BU are provided. Needless to say, in practice, any other number of battery units BU can be provided. It is also assumed that the ID number assigned to the battery unit BU[i] is “i” (where i is an integer).

The communication portion 61 executes basic communication operation in which it transmits a command including a data request command to a plurality of battery units BU sequentially and receives in reply to the command a response signal from the plurality of battery units BU sequentially. Basic communication operation serves as communication operation for acquiring battery status data; as shown in FIG. 6, it includes transmitting a command 311, receiving a response signal 312, transmitting a command 313, and receiving a response signal 314.

More specifically, in basic communication operation, the communication portion 61 delivers a command 311 having an ID number “1” added to it to the communication line CL_{B}. Of all the battery units BU[1] to BU[n], only the battery unit BU[1] corresponding to the ID number “1” responds to the command 311, and the unit control portion 32 of the battery unit BU[1] returns a response signal 312 including the latest battery status data in the battery unit BU[1]. After receiving the response signal 312, the communication portion 61 delivers a command 313 having an ID number “2” added to it to the communication line CL_{B}. Of all the battery units BU[1] to BU[n], only the battery unit BU[2] corresponding to the ID number “2” responds to the command 313, and the unit control portion 32 of the battery unit BU[2] returns a response signal 314 including the latest battery status data in the battery unit BU[2]. In a case where n=2, when the communication portion 61 has received the response signal 314, it concludes one session of basic communication operation. In a case where more battery units BU are provided, basic communication operation includes similar communication operation for the other battery units BU.

The communication portion 61 performs basic communication operation periodically, at predetermined time intervals INT_{B} (for example, at intervals of one to several seconds). The main control portion 60 stores the battery status data received by the communication portion 61 in a buffer memory 70, comprising a DRAM (dynamic random-access memory) or the like, provided in the battery management portion 21 (for example, in the main control portion 60). Here, so that only the latest battery status data on each battery unit BU may be held in the buffer memory 70, the battery status data stored in the buffer memory 70 can be updated every time new battery status data is received.

Independently of the communication by the communication portion 61, the communication portion 62 receives a command 321 including a data request command from the power conversion control portion 11. In reply to reception of the command 321, the communication portion 62 transmits a response signal 322 including processed battery status data to the power conversion control portion 11. The processed battery status data (the contents of the response signal 322) is generated by the main control portion 60 based on the latest battery status data stored in the buffer memory 70. The processed battery status data is data obtained by converting the latest battery status data on the n battery units BU into a predetermined data format, but can instead be the latest battery status data, as it is, on the n battery units BU. Unless a communication fault or the like is present, such a command 321 is transmitted periodically at predetermined time intervals INT_{S} (for example, at intervals of one to several seconds) from the power conversion control portion 11 to be received by the communication portion 62, with the result that a response signal 322 is transmitted periodically at the same time intervals INT_{S} from the communication portion 62 to the power conversion control portion 11.

### Fault Monitoring and Protection Operation

The main control portion 60 monitors whether or not a fault has occurred in the battery block BB, the battery management portion 21, and the breaker portion 22 in the electric power system 1. Faults monitored by the main control portion 60 include a fault due to overcharging (overcharging fault), a fault due to overdischarging (overdischarging fault), a fault due to an overcurrent (overcurrent fault), a temperature fault, a sensor fault, and a communication fault. All these can be understood as faults in the battery unit BU or in the battery management portion 21.

A fault due to overcharging is, for example, a state where the battery voltage value of any battery unit BU remains over a predetermined reference voltage value V_{THU} for a predetermined length of time or longer. A fault due to overdischarging is a state where the battery voltage value of any battery unit BU remains under a predetermined reference voltage value V_{THL} for a predetermined length of time or longer (V_{THU}>V_{THL}). A fault due to an overcurrent is, for example, a state where the battery current value of any battery unit BU remains over a predetermined reference current value I_{THU} for a predetermined length of time or longer. A temperature fault is, for example, a state where the battery temperature of any battery unit BU or the temperature measured by the temperature sensor 67 stays out of a predetermined temperature range for a predetermined length of time or longer.

A sensor fault can be a fault in the sensors 33, 34, and 35 in any battery unit BU, and can also be a fault in the temperature sensor 67. For example, a state where the battery current value, battery voltage value, or battery temperature measured by the sensor 33, 34, or 35 falls outside predetermined ranges of current, voltage, or temperature is understood as a fault in the sensor 33, 34, or 35. For example, a state where the temperature measured by the temperature sensor 67 falls outside a predetermined temperature range is understood as a fault in the temperature sensor 67.

A communication fault can be a first communication fault which is a communication fault between the battery management portion 21 (that is, the communication portion 61) and any battery unit BU or a second communication fault which is a communication fault between the power conversion control portion 11 and the battery management portion 21 (that is, the communication portion 62). A first communication fault can be, for example, a state where, in reply to a command (for example, 311 or 313) from the communication portion 61, no response signal (for example, 312 or 314) from a battery unit BU is received by the communication portion 61. A second communication fault can be, for example, a state where a command 321 expected to be transmitted periodically from the power conversion control portion 11 is not received by the communication portion 62 for a predetermined length of time or longer.

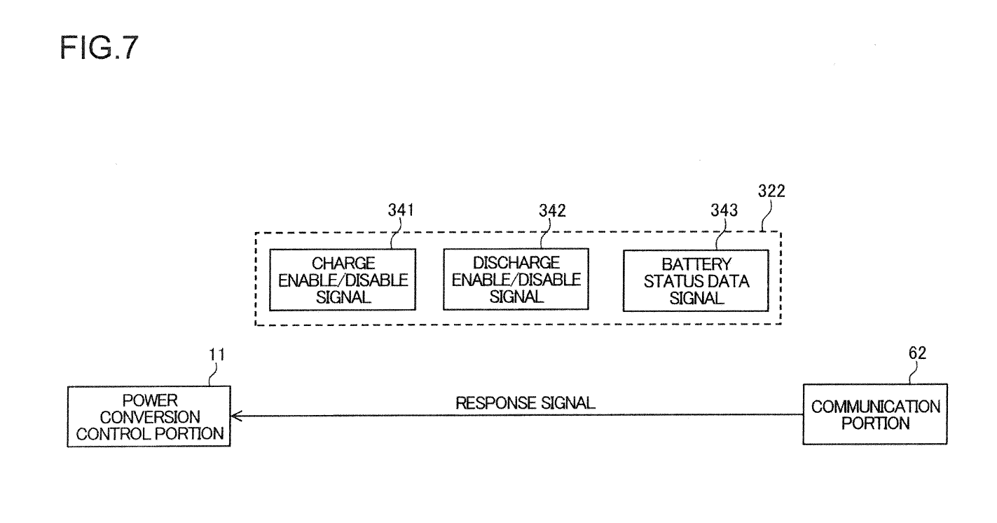

Based on the battery status data received from each battery unit BU, the temperature measured by the temperature sensor 67, and the communication status in the communication portions 61 and 62, the main control portion 60 integrates a request or notification related to the charging or discharging of the battery module 31 into a response signal 322 which the main control portion 60 transmits to the power conversion control portion 11. Specifically, based on the battery status data received from each battery unit BU and the temperature measured by the temperature sensor 67, the main control portion 60 checks whether or not an overcharge fault, overdischarge fault, overcurrent fault, temperature fault, or sensor fault is present. Moreover, based on the signal reception status in the communication portions 61 and 62, the main control portion 60 checks whether or not a first or second communication fault is present. The main control portion 60 generates a charge enable/disable signal 341 and a discharge enable/disable signal 342 reflecting the results of those checks, and integrates them into a response signal 322 (see FIG. 7). A response signal 322 can include only either of the signals 341 and 342. A battery status data signal 343 indicating the latest battery status data on each battery unit BU can also be integrated into a response signal 322 (see FIG. 7).

The signals 341 and 342 are each a flag that has a digital value (logical value) of either 0 or 1 at a time. A signal 341 having a value of 0 acts as a charge enable signal to enable the charging of the battery module 31; a signal 341 having a value of 1 acts as a charge disable signal to indicate the necessity to disable the charging of the battery module 31. A signal 342 having a value of 0 acts as a discharge enable signal to enable the discharging of the battery module 31; a signal 342 having a value of 1 acts as a discharge disable signal indicating the necessity to disable the discharging of the battery module 31. For example, in a case where a charge disable flag (see FIG. 3) having a value of 1 indicates the necessity to disable charging, the main control portion 60 can take, as the value of a signal 341, the logical sum (OR) of the n charge disable flags for the n battery units BU. In a case where a discharge disable flag (see FIG. 3) having a value of 1 indicates the necessity to disable discharging, the main control portion 60 can take, as the value of a signal 342, the logical sum (OR) of the n discharge disable flags for the n battery units BU.

When an overcharge fault, overdischarge fault, overcurrent fault, or temperature fault is present in a battery unit BU, from the perspective of protecting the battery unit BU, charge operation and/or discharge operation should be stopped. On the other hand, when a sensor fault or communication fault is present, due to inconveniences such as the inability to accurately recognize the status of the battery units BU as the target of protection, it is undesirable, for safety reasons, to continue charge operation and/or discharge operation. Accordingly, on occurrence of a fault, the main control portion 60 substitutes “1” in either or both of signals 341 and 342 in accordance with the type of the fault present, and thereby requests the power conversion control portion 11 to disable charging or discharging. If a received response signal 322 includes a charge disable signal (that is, a signal 341 having a value of 1), the power conversion control portion 11 controls the power conversion circuit 12 so that charge operation is stopped immediately; if a received response signal 322 includes a discharge disable signal (that is, a signal 342 having a value of 1), the power conversion control portion 11 controls the power conversion circuit 12 so that discharge operation is stopped immediately.

The generation and transmission of a charge disable signal or a discharge disable signal by the battery management portion 21 corresponds to first protection operation for the battery units BU. When a charge disable signal is transmitted during charge operation, or when a discharge disable signal is transmitted during discharge operation, the battery current value is supposed to quickly fall to zero (or substantially zero), but this may not happen if the power conversion circuit 12 has a fault or the power conversion control portion 11 is not operating properly.

With this taken into consideration, the battery management portion 21, after transmitting a charge disable signal or a discharge disable signal, executes second protection operation, which can be understood as additional protection operation. The second protection operation will now be described. In second protection operation, the main control portion 60 monitors a target current value I_{TG}, and if the magnitude of the target current value I_{TG} does not fall to or below a positive predetermined value I_{TH} even a predetermined length of time TH_{TIME} after the timing of the transmission of a charge disable signal or discharge disable signal by the communication portion 62, the main control portion 60 can turn the breaker portion 22 from on to off. If, the predetermined length of time TH_{TIME} after the above-mentioned timing of the transmission, the target current value I_{TG} is equal to or less than the predetermined value I_{TH}, the main control portion 60 can keep the breaker portion 22 on. In a case where a charge disable signal is transmitted from the communication portion 62, the target current value I_{TG} is the battery current value during the charging of any battery unit BU, and can be the sum of, or the average of, or the maximum value among the measured battery current values during the charging of the battery units BU[1] to BU[n]. In a case where a discharge disable signal is transmitted from the communication portion 62, the target current value I_{TG} is the battery current value during the discharging of any battery unit BU, and can be the sum of, or the average of, or the maximum value among the measured battery current values during the discharging of the battery units BU[1] to BU[n].

Immediately before turning the breaker portion 22 from on to off in second protection operation or the like, the main control portion 60 can save the latest battery status data received from each battery unit BU in the non-volatile memory 68. By exploiting the so saved data, it is easier to investigate what has caused the breaker portion 22 to turn off, facilitating restoration operation.

As will be understood from the above description, the battery units BU themselves have no charging/discharging control function, and rely mainly on the power conversion control portion 11 and the power conversion circuit 12 for charging/discharging control. The power conversion control portion 11 and the power conversion circuit 12 can be such as are incorporated in devices called power controllers, and such a power controller can be combined with a solar cell unit as an example of the power block PB1 to build a solar cell system (in that case, the power block PB2 is, for example, a load or an electric power system). In a possible application of this type of solar cell system, a battery unit is added to build a solar cell system having a power storage function. In one practical example of such an application, a battery unit BU can be additionally connected to an existing, separately provided solar cell system. When a solar cell system having a power storage function is considered as a whole, power conversion control is important which encompasses, for example, charge/discharge control and, with respect to the solar cell system, power generation control and reverse power flow control. However, apart from that, protection of the battery unit BU is also important. In particular, for example, in an application where a battery unit BU is connected to an exiting solar power system, relying on the exiting solar power system for protection of the battery unit BU leaves concerns about the stability of protection. With this taken into consideration, in this embodiment, the battery management portion 21 is provided as a mediator between, at one end, the power conversion control portion 11 and the power conversion circuit 12 and, at the other, the battery unit BU, so that the battery management portion 21 plays a central role to realize a protection function (first and second protection operation) utilizing communication.

### Normal Operation Mode and Intermittent Operation Mode

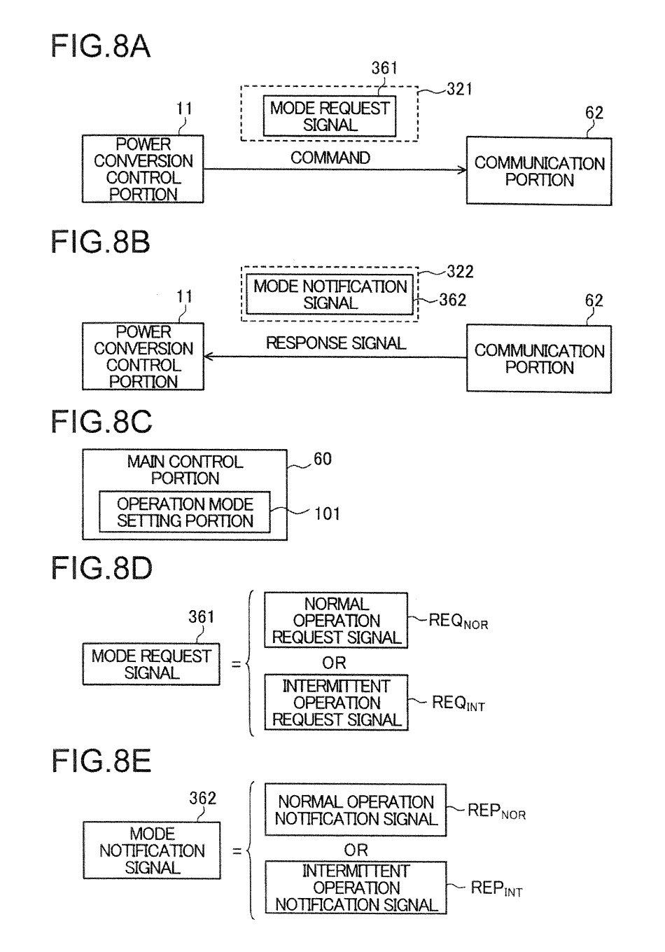

The battery management portion 21 (main control portion 60) operates in one of a plurality of operation modes, and the operation mode in which the battery management portion 21 is actually operating is called the target operation mode. As shown in FIG. 8A, a command 321 directed to the battery management portion 21 includes a mode request signal 361 inquiring which operation mode to set as the target operation mode (in other words, a mode designation signal for designating an operation mode to be set as the target operation mode). According to a mode request signal 361 received from the power conversion control portion 11 via the communication portion 62, the main control portion 60 sets the target operation mode by selecting one out of the plurality of operation modes. An operation mode setting portion 101 for such selection and setting is provided within the main control portion 60 (see FIG. 8C). As shown in FIG. 8B, under the control of the main control portion 60, the communication portion 62 can transmit, in a form integrated in a response signal 322, a mode notification signal 362 for notifying which operation mode is currently the target operation mode to the power conversion control portion 11.

The plurality of operation modes as candidates for the target operation mode include at least a normal operation mode and an intermittent operation mode, and in different operation modes, communication proceeds in different manners.

When the normal operation mode is set as the target operation mode, the battery management portion 21 performs normal operation. In normal operation, the communication portions 61 and 62 conduct communication on a continuous basis. The communication operation by the communication portions 61 and 62 described previously with reference to FIG. 6 corresponds to normal operation. Specifically, in normal operation, basic communication operation by the communication portion 61 is repeated periodically at predetermined time intervals INT_{B} (for example, at intervals of one to several seconds), and a command 321 is transmitted periodically at predetermined time intervals INT_{S} (for example, at intervals of one to several seconds) from the power conversion control portion 11 to be received by the communication portion 62. As a result, a response signal 322 is transmitted periodically at the same time intervals INT_{S} from the communication portion 62 to the power conversion control portion 11.

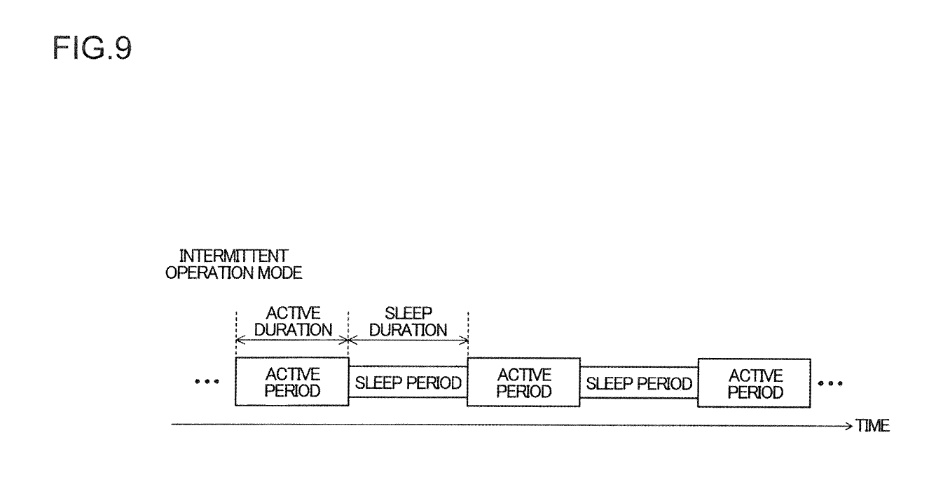

When the intermittent operation mode is set as the target operation mode, the battery management portion 21 performs intermittent operation. In intermittent operation, the communication by the communication portions 61 and 62 is intermittently suspended. Specifically, when the target operation mode is the intermittent operation mode, as shown in FIG. 9, active periods, in which the communication portions 61 and 62 conduct communication, and sleep periods, in which the communication by the communication portions 61 and 62 is suspended, occur alternately. The length of time of one active period is referred to as the active duration, and the length of time of one sleep period is referred to as the sleep duration. The sleep duration is at least longer than the transmission interval between two commands (for example, commands 311 and 313 in FIG. 6) transmitted from the communication portion 61 in normal operation mode. The sleep duration can be set to be longer than the above-mentioned interval INT_{B} (and INT_{S}). It should be noted that a whole period during which the target operation mode remains the normal operation mode is counted as an active period.

The main control portion 60 makes the communication portions 61 and 62 conduct communication in a manner complying with the target operation mode. Specifically, when the target operation mode is the normal operation mode, the main control portion 60 keeps the switch 66 (see FIG. 5) on so that the communication supply voltages (V[3.3] and V[5]) are generated continuously. On the other hand, when the target operation mode is the intermittent operation mode, the main control portion 60 keeps the switch 66 on during active periods and keeps the switch 66 off during sleep periods. As a result, in active periods, the communication portions 61 and 62 conduct communication in a similar manner as in the normal operation mode; by contrast, in sleep periods, the communication portions 61 and 62 are not supplied with the communication supply voltages as their driving voltages, and thus do not conduct any transmission or reception operation.

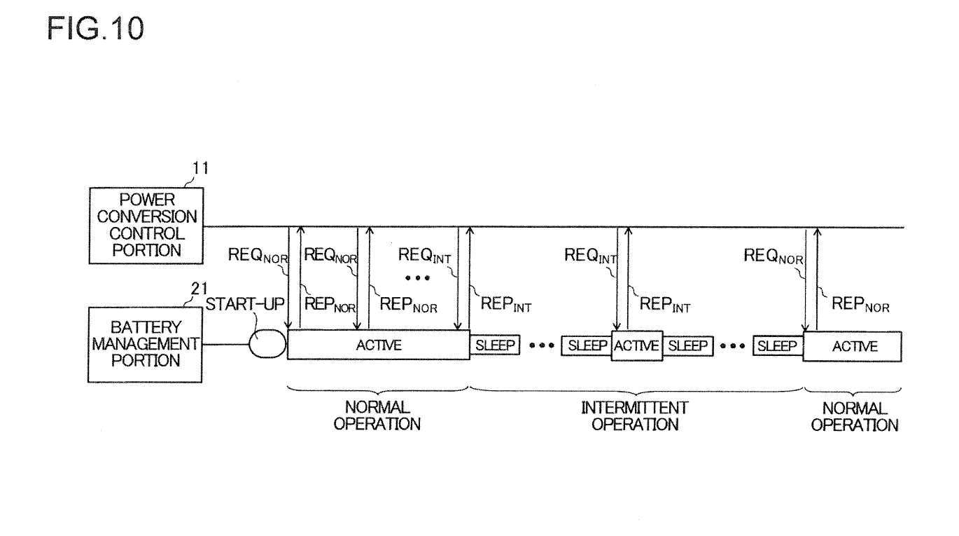

For example in a time zone when completely or almost no discharging or charging of the battery unit BU is expected to take place, the power conversion control portion 11 can instruct, by transmitting a mode request signal 361, the battery management portion 21 to perform intermittent operation. As shown in FIG. 8D, a mode request signal 361 can be either a normal operation request signal REQ_{NOR} which demands that the normal operation mode be set as the target operation mode or an intermittent operation request signal REQ_{INT} which demands that the intermittent operation mode be set as the target operation mode. As shown in FIG. 8E, a mode notification signal 362 can be either a normal operation notification signal REP_{NOR} which notifies that the normal operation mode is set as the target operation mode or an intermittent operation notification signal REP_{INT} which notifies that the intermittent operation mode is set as the target operation mode. For example, in a case where a signal 361 is a one-bit signal, a signal 361 having a value of “0” serves as a signal REQ_{NOR}, and a signal 361 having a value of “1” serves as a signal REQ_{INT} (a similar explanation applies to a signal 362). FIG. 10 shows an outline of signal exchange related to switching between the normal operation mode and the intermittent operation mode. In normal operation, signals REQ_{NOR} and REP_{NOR} are exchanged, and when the communication portion 61 receives a signal REQ_{INT}, it returns a signal REP_{INT} to switch to intermittent operation. Thereafter, when the communication portion 61 receives a signal REQ_{NOR}, it returns a signal REP_{NOR} to switch back to normal operation. Any mode request signal 361 (REQ_{NOR} or REQ_{INT}) that can be transmitted from the power conversion control portion 11 during sleep periods is ignored by the battery management portion 21.

The above-mentioned plurality of operation modes can include any operation mode other than the normal operation mode and the intermittent operation mode. For example, they can include a hibernation mode. When the hibernation mode is set as the target operation mode, the main control portion 60 keeps the switch 66 off until a particular input is fed to the battery management portion 21 from outside (for example, until a particular signal is fed from the power conversion control portion 11 to the main control portion 60).

In the configuration example shown in FIG. 5, the converter 63 and the communication power supply circuit 64 can be understood to constitute a communication voltage generation portion for generating the driving voltages for the communication portions 61 and 62 based on the discharge electric power from the battery unit BU. In sleep periods, the main control portion 60 suspends the communication by the communication portions 61 and 62 by stopping the supply of the discharge electric power to the communication voltage generation portion. In intermittent operation, no electric power is consumed in sleep periods by the converter 63 or the communication power supply circuit 64 itself, or by any block driven by the voltages those generate, and thus power saving is achieved.

Even in a period when intermittent operation is performed, in active periods, as in normal operation, the communication function and the protection function (first and second protection operation) of the battery management portion 21 are active. In sleep periods, however, the communication function of the battery management portion 21 is inactive, with the result that the protection function achieved by utilizing the communication function is inactive. It is therefore advisable, with a view to securing the safety of the battery unit BU, to control whether or not to perform intermittent operation and what to perform in it according to the situation at hand.

Some application examples related to intermittent operation will be described below. Unless inconsistent, any part of the description given thus far applies equally to the application examples presented below. Unless inconsistent, any of the plurality of application examples presented below can be combined with any other.

### First Application Example of Intermittent Operation

A first application example related to intermittent operation will be described. In intermittent operation, lengthening sleep periods helps enhance the power saving effect, but excessively long sleep periods, since these are periods when the communication function and the protection function are inactive, can lead to slack control for safety. With this taken into consideration, in the first example of application example, when the intermittent operation mode is set as the target operation mode, the main control portion 60 sets at least one of the active duration and the sleep duration variably (such that it can be varied) based on battery status data. In the following description, for the sake of simple designation, the operation performed by the main control portion 60 to achieve variable setting of at least one of the active duration and the sleep duration will be referred to as variable setting operation. The battery status data used in variable setting operation can be the latest battery status data that the main control portion 60 has acquired via the communication portion 61 prior to variable setting operation. The main control portion 60 can perform variable setting operation at the start of intermittent operation, or can perform variable setting operation with any timing during execution of intermittent operation.

With respect to the active duration, a reference duration REF_{ACT} (for example, five seconds) is prescribed, and with respect to the sleep duration, a reference duration REF_{SLP} (for example, 25 seconds) is prescribed. The reference durations REF_{ACT} and REF_{SLP} can be durations specified by the power conversion control portion 11. For example, the power conversion control portion 11 can, when transmitting an intermittent operation request signal REQ_{INT} (see FIG. 8D), integrate a signal specifying the reference durations REF_{ACT} and REF_{SLP} into a command 321. Or the main control portion 60 can previously set the reference durations REF_{ACT} and REF_{SLP}. The main control portion 60 takes as an initial state a state where the active duration and the sleep duration are equal to the reference durations REF_{ACT} and REF_{SLP} respectively, and by modifying it according to battery status data performs variable setting operation. Variable setting operation will be described below chiefly on the assumption that n≧2, but it can also be that n=1 (the same applies to the other application examples described later). The active duration and the sleep duration can instead be defined within a predetermined duration (for example, 30 seconds) set as the sum of one active period and one sleep period.

### Variable Setting Operation Based on Battery Current Value

As battery status data, the battery current value of each battery unit BU can be used. The battery current value represents the current value in the charging or discharging of the battery module 31, and can have a zero value, a positive value (charging), or a negative value (discharging) (the same applies to the other application examples described later). In a case where the battery current value is used as the battery status data, the main control portion 60 sets an evaluation current value based on the battery current value of each battery unit BU. In a case where n=1, the evaluation current value equals the absolute value of the battery current value of the battery unit BU[1]. In a case where n≧2, the evaluation current value equals, for example, the sum of, or the average of, or the maximum value among, or any one of the battery current values of the battery units BU[1] to BU[n].

The main control portion 60 compares the evaluation current value with a predetermined threshold value I_{THA1} (I_{THA1}≧1). If the evaluation current value is equal to or less than the threshold value I_{THA1}, the main control portion 60 sets the reference durations REF_{ACT} and REF_{SLP} as the active duration and the sleep duration as in the initial state. On the other hand, if the evaluation current value is larger than the threshold value I_{THA1}, the main control portion 60 increases the active duration alone, or decreases the sleep duration alone, or increases the active duration and in addition decreases the sleep duration relative to the initial state. Here, as the evaluation current value increases, the amount of increase of the active duration and the amount of decrease of the sleep duration can be increased. Needless to say, increasing the active duration relative to the initial state means increasing the active duration from the reference duration REF_{ACT}, and decreasing the sleep duration relative to the initial state means decreasing the sleep duration from the reference duration REF_{SLP}.

If the evaluation current value is equal to or larger than a predetermined threshold value I_{THA2} (I_{THA2}>I_{THA1}), the main control portion 60 can set the sleep duration to be zero. That is, even when the communication portion 62 receives an intermittent operation request signal REQ_{INT}, the target operation mode can be set for the normal operation mode so that normal operation is performed.

### Variable Setting Operation Based on Battery Temperature

As battery status data, the battery temperatures of the battery units BU[1] to BU[n] (hereinafter referred to as the n battery temperatures) can be used.

The main control portion 60 checks whether or not each battery temperature falls within a predetermined temperature range TMP_{RNG}. If all the n battery temperatures fall within the temperature range TMP_{RNG}, the main control portion 60 sets the reference durations REF_{ACT} and REF_{SLP} as the active duration and the sleep duration as in the initial state. On the other hand, if, among the n battery temperatures, there is any battery temperature (hereinafter referred to as a deviated temperature) that falls outside the temperature range TMP_{RNG}, the main control portion 60 increases the active duration alone, or decreases the sleep duration alone, or increases the active duration and in addition decreases the sleep duration relative to the initial state. Here, as the deviated temperature deviates further from the temperature range TMP_{RNG}, the amount of increase of the active duration and the amount of decrease of the sleep duration can be increased. That is, when the deviated temperature is higher than the upper limit temperature of the temperature range TMP_{RNG}, as the difference between the deviated temperature and the upper limit temperature increases, the main control portion 60 can increase the amount of increase of the active duration and the amount of decrease of the sleep duration. Likewise, when the deviated temperature is lower than the lower limit temperature of the temperature range TMP_{RNG}, as the difference between the deviated temperature and the lower limit temperature increases, the main control portion 60 can increase the amount of increase of the active duration and the amount of decrease of the sleep duration. In a case where n≧2, the deviated temperature that determines the amount of increase of the active duration and the amount of decrease of the sleep duration is the maximum or minimum value among the n battery temperatures, and is the battery temperature farthest from the temperature range TMP_{RNG} among the n battery temperatures.

The temperature range TMP_{RNG} is, for example, part (around the center) of a prescribed operatable temperature range of the battery module 31. If, for example, any of the n battery temperatures deviates even from a predetermined temperature range TMP_{RNG2}, the main control portion 60 can set the sleep duration to be zero. That is, even when the communication portion 62 receives an intermittent operation request signal REQ_{INT}, the target operation mode can be set for the normal operation mode so that normal operation is performed. The temperature range TMP_{RNG2} contains, and is wider than, the temperature range TMP_{RNG}. The temperature range TMP_{RNG2} can be identical with, or part of, the above-mentioned operatable temperature range.

### Variable Setting Operation Based on Remaining Capacity Data

As battery status data, the remaining capacity data of the battery units BU[1] to BU[n] (hereinafter also referred to as the n remaining capacity data pieces) can be used. As mentioned previously, remaining capacity data is data indicating the remaining capacity or SOC of a battery module 31. As is well known, the SOC of a battery module 31 is the ratio of the capacity remaining in the battery module 31 to the full-charge capacity thereof. In a case where remaining capacity data is a value indicating the remaining capacity, a capacity range (described later) is a range defined in terms of “A·h (amperes per hour)” or the like; in a case where remaining capacity data is a value indicating the SOC, a capacity range (described later) is a range defined in terms of “%.”

The main control portion 60 checks whether or not each remaining capacity data piece falls within a predetermined capacity range CP_{RNG}. If all the n remaining capacity data pieces fall within the capacity range CP_{RNG}, the main control portion 60 sets the reference durations REF_{ACT} and REF_{SLP} as the active duration and the sleep duration as in the initial state. On the other hand, if, among the n remaining capacity data pieces, there is any remaining capacity data piece (hereinafter referred to as a deviated remaining capacity data piece) that falls outside the capacity range CP_{RNG}, the main control portion 60 increases the active duration alone, or decreases the sleep duration alone, or increases the active duration and in addition decreases the sleep duration relative to the initial state. Here, as the deviated remaining capacity data piece deviates further from the capacity range CP_{RNG}, the amount of increase of the active duration and the amount of decrease of the sleep duration can be increased. That is, when the deviated remaining capacity data piece is larger than the upper limit value of the capacity range CP_{RNG}, then, as the difference between the deviated remaining capacity data piece and the upper limit value increases, the main control portion 60 can increase the amount of increase of the active duration and the amount of decrease of the sleep duration. Likewise, when the deviated remaining capacity data piece is smaller than the lower limit value of the capacity range CP_{RNG}, then, as the difference between the deviated remaining capacity data piece and the lower limit value increases, the main control portion 60 can increase the amount of increase of the active duration and the amount of decrease of the sleep duration. In a case where n≧2, the deviated remaining capacity data piece that determines the amount of increase of the active duration and the amount of decrease of the sleep duration is the maximum or minimum value among the n remaining capacity data pieces, and is the remaining capacity data piece farthest from the capacity range CP_{RNG} among the n remaining capacity data pieces.

If, for example, any of the n remaining capacity data pieces deviates even from a predetermined capacity range CP_{RNG2}, the main control portion 60 can set the sleep duration to be zero. That is, even when the communication portion 62 receives an intermittent operation request signal REQ_{INT}, the target operation mode can be set for the normal operation mode so that normal operation is performed. The capacity range CP_{RNG2} contains, and is wider than the capacity range CP_{RNG}. The SOC equivalent values of the upper and lower limits of the capacity range CP_{RNG2}are, for example, 100% (or 100%−Δ) and 0% (or 0%+Δ) respectively (where Δ represents a predetermined value fulfilling 0<Δ<0.5).

### Variable Setting Operation Based on Battery Voltage Value

As battery status data, the battery voltage values of the battery units BU[1] to BU[n] (hereinafter also referred to as the n battery voltage values) can be used. Being terminal voltage values, battery voltage values vary with remaining capacity data, and thus allow operation similar to variable setting operation based on remaining capacity data.

Specifically, the main control portion 60 checks whether or not each battery voltage value falls within a predetermined voltage range V_{RNG}. If all the n battery voltage values fall within the voltage range V_{RNG}, the main control portion 60 sets the reference durations REF_{ACT} and REF_{SLP} as the active duration and the sleep duration as in the initial state. On the other hand, if, among the n battery voltage values, there is any battery voltage value (hereinafter referred to as a deviated voltage value) that falls outside the voltage range V_{RNG}, the main control portion 60 increases the active duration alone, or decreases the sleep duration alone, or increases the active duration and in addition decreases the sleep duration relative to the initial state. Here, as the deviated voltage value further deviates from the voltage range V_{RNG}, the amount of increase of the active duration and the amount of decrease of the sleep duration can be increased. That is, when the deviated voltage value is higher than the upper limit value of the voltage range V_{RNG}, then, as the difference between the deviated voltage value and the upper limit value increases, the main control portion 60 can increase the amount of increase of the active duration and the amount of decrease of the sleep duration. Likewise, when the deviated voltage value is lower than the lower limit value of the voltage range V_{RNG}, then, as the difference between the deviated voltage value and the lower limit value increases, the main control portion 60 can increase the amount of increase of the active duration and the amount of decrease of the sleep duration. In a case where n≧2, the deviated voltage value that determines the amount of increase of the active duration and the amount of decrease of the sleep duration is the maximum or minimum value among the n battery voltage values, and is the battery voltage value farthest from the voltage range V_{RNG} among the n battery voltage values.

If, for example, any of the n battery voltage values deviates even from a predetermined voltage range V_{RNG2}, the main control portion 60 can set the sleep duration to be zero. That is, even when the communication portion 62 receives an intermittent operation request signal REQ_{INT}, the target operation mode can be set for the normal operation mode so that normal operation is performed. The voltage range V_{RNG2} contains, and is wider than, the voltage range V_{RNG}. The upper limit of the voltage range V_{RNG2} corresponds to a voltage level equal to or close to an overcharge voltage level, and the lower limit of the voltage range V_{RNG2} corresponds to a voltage level equal to or close to an overdischarge voltage level.

### Variable Setting Operation Based on a Plurality of Indices

Variable setting operation based on battery current value, battery temperature, remaining capacity data, and battery voltage value has been discussed separately. The main control portion 60 can perform variable setting operation based on two or more of indices comprising battery current value as a first index, battery temperature as a second index, remaining capacity data as a third index, and battery voltage value as a fourth index. For example, the main control portion 60 can perform variable setting operation based on two or more of the first to third indices, or based on two or more of the first, second, and fourth indices. Also in cases where variable setting operation is performed based on two or more indices, the active duration or the sleep duration can be varied according to the relevant indices.

In the first application example of intermittent operation, and also in a second and a third application example of intermittent operation which will be described later, the battery status data is assumed to include all of the first to fourth indices; the battery status data, however, can instead include only any one, two, or three of the first to fourth indices. The main control portion 60 can perform variable setting operation by using one or more indices included in the battery status data.

Insertion of sleep periods signifies disablement of the communication function and the protection function, and this is undesirable from the perspective of protection. However, so long as the charge/discharge current equals zero or is sufficiently low, reasonably long sleep duration or a reasonably short active duration is not considered to pose a serious problem. The same is true when the battery temperature falls around the center of the operatable temperature range, or when the remaining capacity data or the battery voltage value is well away from the overcharge or overdischarge level. However, when the charge/discharge current is relatively high, or when the battery temperature is relatively close to the upper or lower limit of the operatable temperature range, or when the remaining capacity data or the battery voltage value is relatively close to the overcharge or overdischarge level, it is preferable to avoid inactivation of the communication function and the protection function as much as possible, and to monitor the battery status as frequently as possible. On the other hand, power saving resulting from intermittent operation is highly beneficial. By performing the above-described variable setting operation with such factors taken into consideration, it is possible to achieve a satisfactory balance between battery protection and power saving (it is possible to achieve power saving while ensuring the safety of the battery unit BU).

In the example described above, the active duration can vary only in the increasing direction relative to the reference duration REF_{ACT}, and the sleep duration can vary only in the decreasing direction relative to the reference duration REF_{SLP}. However, in a case where, based on at least one of the first to fourth indices mentioned above, no serious problem is expected to be likely in terms of safety, the active duration can be decreased to be smaller than the reference duration REF_{ACT}, and the sleep duration can be increased to be larger than the reference duration REF_{ACT}. For example, in a case where the above-mentioned evaluation current value is equal to or smaller than the threshold value I_{THA1} then, as the evaluation current value decreases, the active duration can be decreased to be smaller than the reference duration REF_{ACT}, and additionally or alternatively the sleep duration can be increased to be larger than the reference duration REF_{SLP}.

### Second Application Example of Intermittent Operation

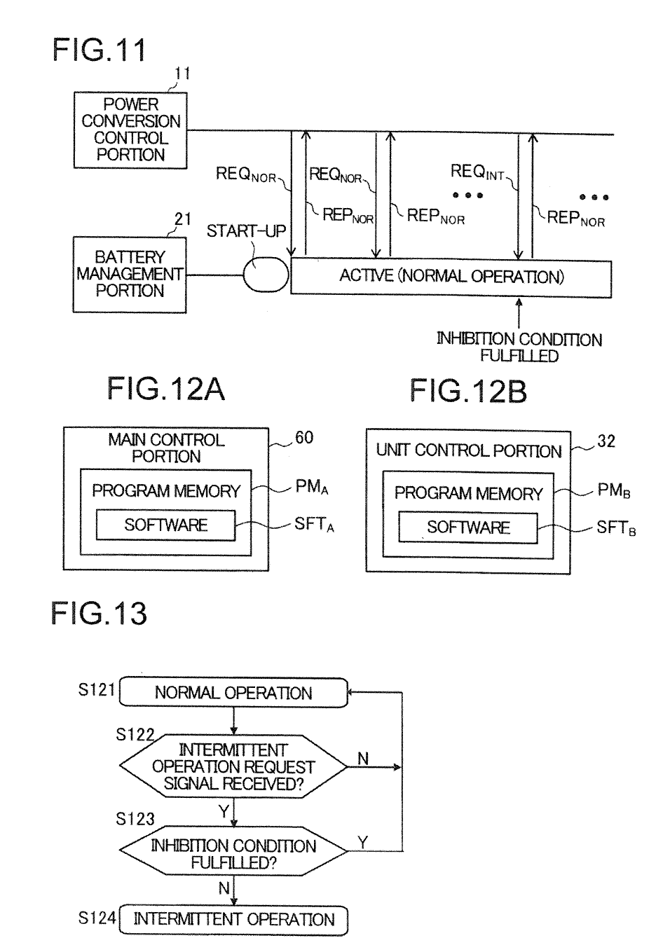

A second application example related to intermittent operation will now be described. Unless inconsistent, any part of the description given thus far including the description of the first application example of intermittent operation applies equally to the second application example. As described previously, the target operation mode is in principle set according to a mode request signal 361 (see FIGS. 8A and 8D); however, in a situation where switching to the intermittent operation mode is undesirable, an instruction to switch to the intermittent operation mode should better be ignored. With this taken into consideration, in the second application example, the operation mode setting portion 101 operates as follows: in normal operation mode, when an intermittent operation request signal REQ_{INT} is received by the communication portion 62, that is, when switching of the target operation mode from the normal operation mode to the intermittent operation mode is requested by a mode request signal 361, the operation mode setting portion 101 checks whether or not a predetermined inhibition condition is fulfilled. If no inhibition condition is fulfilled, the operation mode setting portion 101 switches the target operation mode from the normal operation mode to the intermittent operation mode according to the request signal REQ_{INT}. On the other hand, if an inhibition condition is fulfilled, the operation mode setting portion 101 inhibits switching of the target operation mode from the normal operation mode to the intermittent operation mode, and maintains the normal operation mode as the target operation mode. Thus, for example, it is possible to permit switching to intermittent operation only when intermittent operation can be performed with sufficient safety, leading to enhanced safety. FIG. 11 shows an outline of signal exchange related to inhibition of switching to intermittent operation.

Operation for checking whether or not an inhibition condition is fulfilled is called inhibition condition check operation.

### Inhibition Condition Check Operation Based on Battery Status Data

The operation mode setting portion 101 can perform inhibition condition check operation based on battery status data. The battery status data used in inhibition condition check operation can be the latest battery status data that the main control portion 60 acquires via the communication portion 61 at the timing that inhibition condition check operation is performed. As battery status data, a battery current value, a battery temperature, remaining capacity data, or a battery voltage value is used.

In a case where, as battery status data, the battery current value of each individual battery unit BU is used, then, according to the method described above in connection with the first application example, the operation mode setting portion 101 compares the evaluation current value with a predetermined threshold value I_{THB} (I_{THB}≧0). The operation mode setting portion 101 can determine, if the evaluation current value is equal to or smaller than the threshold value I_{THB}, that no inhibition condition is fulfilled and, if the evaluation current value is larger than the threshold value I_{THB}, that an inhibition condition is fulfilled.

In a case where, as battery status data, the battery temperatures of the battery units BU[1] to BU[n] (the n battery temperatures) are used, the operation mode setting portion 101 checks whether or not each battery temperature falls within a predetermined temperature range TMP_{RNG}. The operation mode setting portion 101 can determine, if all the n battery temperatures fall within the predetermined temperature range TMP_{RNGB}, that no inhibition condition is fulfilled and, if any of the n battery temperatures falls outside the predetermined temperature range TMP_{RNGB}, that an inhibition condition is fulfilled.

In a case where, as battery status data, the remaining capacity data of the battery units BU[1] to BU[n] (the n remaining capacity data pieces) are used, the operation mode setting portion 101 checks whether or not each remaining capacity data piece falls within a predetermined capacity range CP_{RNGB}. The operation mode setting portion 101 can determine, if all the n remaining capacity data pieces fall within the predetermined capacity range CP_{RNG}, that no inhibition condition is fulfilled and, if any of the n remaining capacity data pieces falls outside the capacity range CP_{RNG}, that an inhibition condition is fulfilled.

In a case where, as battery status data, the battery voltage values of the battery units BU[1] to BU[n] (the n battery voltage values as n terminal voltage values) are used, the operation mode setting portion 101 checks whether or not each battery voltage value falls within a predetermined voltage range V_{RNGB}. The operation mode setting portion 101 can determine, if all the n battery voltage values fall within the predetermined voltage range V_{RNGB}, that no inhibition condition is fulfilled and, if any of the n battery voltage values falls outside the voltage range V_{RNGB}, that an inhibition condition is fulfilled.

The operation mode setting portion 101 can perform inhibition condition check operation based on two, three, or four of four indices (first to fourth indices) comprising battery current value, battery temperature, remaining capacity data, and battery voltage value. For example, in a case where the four indices are used, only if the evaluation current value is equal to or smaller than the threshold value I_{THB}, in addition all the n battery temperatures fall within the temperature range TMP_{RNGB}, in addition all the n remaining capacity data pieces fall within the capacity range CP_{RNGB}, and in addition all the n battery voltage values fall within the voltage range V_{RNGB}, it is determined that no inhibition condition is fulfilled; otherwise, it is determined that an inhibition condition is fulfilled.

With the above-described inhibition condition check operation based on battery status data, in a situation where the communication function and the protection function should better be kept active, as in a case where the charge/discharge current is relatively high, switching to intermittent operation can be inhibited. This ensures the safety of the battery unit BU.

### Inhibition Condition Check Operation Based on Presence/Absence of a Fault

The operation mode setting portion 101 can perform inhibition condition check operation based on whether or not a fault is present in a battery unit BU or in the battery management portion 21. Specifically, when the communication portion 62 receives an intermittent operation request signal REQ_{INT}, the operation mode setting portion 101 checks, based on the battery status data received from each battery unit BU and the temperature measured by the temperature sensor 67, whether or not a fault due to overcharging (overcharging fault), a fault due to overdischarging (overdischarging fault), a fault due to an overcurrent (overcurrent fault), a temperature fault, or a sensor fault is present, and also checks, based on the signal reception status in the communication portion 61, whether or not a first communication fault is present. As described previously, a temperature fault can be a temperature fault in the battery module 31 based on the temperature measured by the temperature sensor 35 (see FIG. 2) or a temperature fault in the battery management portion 21 based on the temperature measured by the temperature sensor 67 (see FIG. 5). Of the seven kinds of faults comprising an overcharge fault, an overdischarge fault, an overcurrent fault, a temperature fault in the battery module 31, a temperature fault in the battery management portion 21, a sensor fault, and a first communication fault, only any one, two, three, four, five, or six can be taken as the target of the check for a fault.

If any of an overcharge fault, an overdischarge fault, an overcurrent fault, a temperature fault in the battery module 31, a temperature fault in the battery management portion 21, a sensor fault, and a first communication fault is found to be present, the operation mode setting portion 101 can determine that an inhibition condition is fulfilled; if none of those errors is found to be present, the operation mode setting portion 101 can determine that no inhibition condition is fulfilled.

With the above-described inhibition condition check operation based on presence/absence of a fault, on occurrence of a fault, that is, in a situation where the communication function and the protection function should be active to curb aggravation of the fault, switching to intermittent operation can be inhibited. This ensures the safety of the battery unit BU.

### Inhibition Condition Check Operation Related to Software Updating Operation

As shown in FIG. 12A, software SFT_{A} that determines the operation of the battery management portion 21 (in particular, the main control portion 60) is stored in a program memory PM_{A}, comprising a flash memory or the like, provided within the main control portion 60. The main control portion 60, by running the software SFT_{A} on an operation processor (such as a CPU) provided in it, realizes the above-described operation and control by the main control portion 60. Likewise, as shown in FIG. 12B, in each battery unit BU, software SFT_{B} that determines the operation of the battery unit BU (in particular, the unit control portion 32) is stored in a program memory PM_{B}, comprising a flash memory or the like, provided within the unit control portion 32. The unit control portion 32, by running the software SFT_{B} on an operation processor (such as a CPU) provided in it, realizes the above-described operation and control by the unit control portion 32 (including operation for generating battery status data, and operation for transmitting signals including battery status data to the communication portion 61).

The power conversion control portion 11 transmits to the communication portion 62 an update signal A_{UPDATE} for updating the software SFT_{A}. The update signal A_{UPDATE} includes a signal requesting the updating of the software SFT_{A} and the code of the updated software SFT_{A}. When an update signal A_{UPDATE} is received by the communication portion 62, according to the contents of the update signal A_{UPDATE}, the main control portion 60 updates the software SFT_{A} by using a predetermined boot loader program. Likewise, the power conversion control portion 11 transmits to the communication portion 62 an update signal B_{UPDATE} for updating the software SFT_{B}. The update signal B_{UPDATE} that corresponds to the software SFT_{B} in the battery unit BU[i] is represented by the symbol B_{UPDATE}[i]. The update signal B_{UPDATE}[i] includes a signal requesting the updating of the software SFT_{B} in the battery unit BU[i] and the code of the updated software SFT_{B}. When an update signal B_{UPDATE}[i] is received by the communication portion 62, the main control portion 60 transmits, via the communication portion 61, the update signal B_{UPDATE}[i] to the battery unit BU[i]. On receiving the update signal B_{UPDATE}[i], the unit control portion 32 in the battery unit BU[i] updates, according to the content of the update signal B_{UPDATE}[i], its own software SFT_{B} by using a predetermined boot loader program.

During execution of updating operation for the software SFT_{A} (operation for updating the software SFT_{A}), execution of basic communication operation is stopped, and thus the protection function exploiting basic communication operation is inactive. Likewise, during execution of updating operation for the software SFT_{B} (operation for updating the software SFT_{B}) in the battery unit BU[i], generation of battery status data in the battery unit BU[i] and transmission of battery status data from the battery unit BU[i] to the communication portion 61 (in other words, reception of battery status data from the battery unit BU[i] by the communication portion 61) is stopped, and thus the protection function according to battery status data of the battery unit BU[i] becomes inactive. In a state where the protection function is entirely or partly inactive, it is undesirable to permit switching to intermittent operation, which may further diminish the protection function.

With this taken into consideration, the operation mode setting portion 101 can perform inhibition condition check operation based on whether or not updating operation for the software SFT_{A} or SFT_{B} is being executed. Specifically, the operation mode setting portion 101 can determine, during execution of updating operation for the software SFT_{A} or SFT_{B}, that an inhibition condition is fulfilled and, except during execution of updating operation for the software SFT_{A} or SFT_{B}, that no inhibition condition is fulfilled.

With the configuration described above, during execution of software updating operation, during which time the communication function should not be inactive, switching to intermittent operation is inhibited. It is thus possible to update software properly without unduly lowering the safety of the battery unit BU.

### Operation Flow

FIG. 13 is a flow chart of the operation of the battery management portion 21 in the second application example. During execution of normal operation (step S121), if an intermittent operation request signal REQ_{INT} is received by the communication portion 62 (step S122, Y), whether or not an inhibition condition is fulfilled is checked (step S123). If no inhibition condition is fulfilled, execution of intermittent operation is started (step S124); if an inhibition condition is fulfilled, normal operation is continued.

### Third Application Example of Intermittent Operation

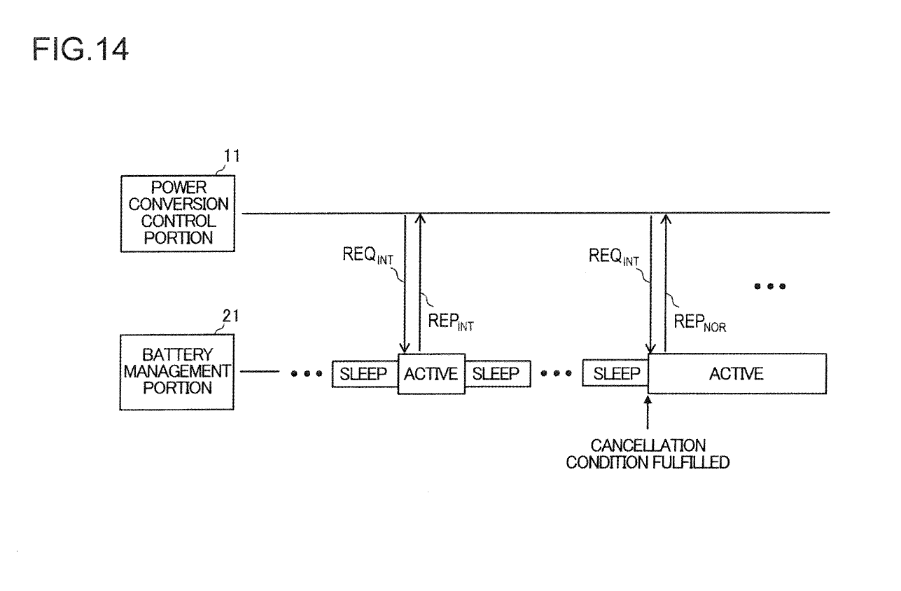

A third application example related to intermittent operation will now be described. Unless inconsistent, any part of the description given thus far including the description of the first and second application examples of intermittent operation applies equally to the third application example. It may occur that, while intermittent operation is being performed according to an intermittent operation request signal REQ_{INT}, a situation arises where continuation of intermittent operation is undesirable. With this taken into consideration, in the third application example, when the target operation mode is the intermittent operation mode, the operation mode setting portion 101 constantly monitors and checks whether or not a predetermined cancellation condition is fulfilled. Unless a predetermined cancellation condition is fulfilled, the operation mode setting portion 101 maintains the intermittent operation mode as the target operation mode. On the other hand, if a predetermined cancellation condition is fulfilled, regardless of the reception status and received contents of the mode request signal 361 in the communication portion 62, the operation mode setting portion 101 switches the target operation mode from the intermittent operation mode to the normal operation mode. Thus, when the target operation mode is the intermittent operation mode, if a predetermined cancellation condition is fulfilled, even when a mode request signal 361 requesting switching of the target operation mode to the normal operation mode (that is, a normal operation request signal REQ_{NOR}) is not received by the communication portion 62, the operation mode setting portion 101 switches the target operation mode from the intermittent operation mode to the normal operation mode. Thus, for example, in a situation where the top priority is ensuring safety, it is possible to forcibly return to normal operation, leading to enhanced safety. Here, a state where a mode request signal 361 requesting switching of the target operation mode to the normal operation mode (that is a normal operation request signal REQ_{NOR}) is not received by the communication portion 62 can be a state where the communication portion 62 has received an intermittent operation request signal REQ_{INT} and has thus been requested to maintain the target operation mode in the intermittent operation mode, and a state where, due to a second communication fault, a mode request signal 361 itself is not received by the communication portion 62. FIG. 14 shows an outline of signal exchange related to forcible returning to normal operation.

Operation for checking fulfillment/non-fulfillment of a cancellation condition (that is, operation for checking whether or not a cancellation condition is fulfilled) is called cancellation condition check operation. During execution of intermittent operation, the operation mode setting portion 101 can constantly check fulfillment/non-fulfillment of a cancellation condition.

### Cancellation Condition Check Operation Based on Battery State Data

The operation mode setting portion 101 can perform cancellation condition check operation based on battery status data. The battery status data used in cancellation condition check operation can be the latest battery status data that the main control portion 60 acquires via the communication portion 61 at the timing that cancellation condition check operation is performed. The operation mode setting portion 101 can perform cancellation condition check operation every time the latest battery status data is acquired via the communication portion 61.

Cancellation condition check operation based on battery status data can be similar to inhibition condition check operation based on battery status data in the second application example. The operation mode setting portion 101 can perform cancellation condition check operation based on at least one of a battery current value, a battery temperature, remaining capacity data, and a battery voltage value included in battery status data. The specific operation of inhibition condition check operation based on battery status data described previously in connection with the second application example can be applied to cancellation condition check operation based on battery status data. In that case, “inhibition condition” and “inhibition condition check operation” in the description of the second application example have simply to be read “cancellation condition” and “cancellation condition check operation” (that is, on the assumption that an inhibition condition being fulfilled is the counterpart of a cancellation condition being fulfilled and that an inhibition condition not being fulfilled is the counterpart of a cancellation condition not being fulfilled). Accordingly, when the previously-mentioned evaluation current value is higher than the threshold value I_{THB}, it can be determined that a cancellation condition is fulfilled.

With cancellation condition check operation based on battery status data, in a situation where status monitoring and protection of the battery unit BU should better be performed constantly, as in a case where the charge/discharge current is relatively high, forcible switching is performed to normal operation, where status monitoring and protection of the battery unit BU can be performed constantly. This ensures the safety of the battery unit BU.

### Cancellation Condition Check Operation Based on Presence/Absence of a Fault

The operation mode setting portion 101 can perform cancellation condition check operation based on whether or not a fault is present in the battery units BU or in the battery management portion 21. Specifically, during execution of intermittent operation, based on the battery status data received from each battery unit BU and the temperature measured by the temperature sensor 67, the operation mode setting portion 101 checks whether or not a fault due to overcharging (overcharging fault), a fault due to overdischarging (overdischarging fault), a fault due to an overcurrent (overcurrent fault), a temperature fault, or a sensor fault is present. Moreover, based on signal reception status in the communication portions 61 and 62, the operation mode setting portion 101 checks whether or not a first or second communication fault is present. As described previously, a temperature fault can be a temperature fault in the battery module 31 based on the temperature measured by the temperature sensor 35 (see FIG. 2) or a temperature fault in the battery management portion 21 based on the temperature measured by the temperature sensor 67 (see FIG. 5). Of the eight kinds of faults comprising an overcharge fault, an overdischarge fault, an overcurrent fault, a temperature fault in the battery module 31, a temperature fault in the battery management portion 21, a sensor fault, a first communication fault, and a second communication fault, only any one to seven can be taken as the target of the check for a fault.

The operation mode setting portion 101 can determine that a cancellation condition is fulfilled if any of an overcharge fault, an overdischarge fault, an overcurrent fault, a temperature fault in the battery module 31, a temperature fault in the battery management portion 21, a sensor fault, a first communication fault, and a second communication fault is found to be present. The operation mode setting portion 101 can determine that no cancellation condition is fulfilled if none of those errors is found to be present.

With the above-described cancellation condition check operation based on presence/absence of a fault, on occurrence of a fault, that is, in a situation where the communication function and the protection function should be activated to curb aggravation of the fault, forcible switching is made to normal operation, where those functions are constantly active. This ensures the safety of the battery unit BU.

### Cancellation Condition Check Operation Related to Software Updating Operation

During execution of intermittent operation, the operation mode setting portion 101 can monitor whether or not an update signal A_{UPDATE} or B_{UPDATE}[i], which can be transmitted from the power conversion control portion 11, is received by the communication portion 62 so that, based on whether or not either is received, the operation mode setting portion 101 performs cancellation condition check operation. Specifically, the operation mode setting portion 101 determines, if an update signal A_{UPDATE} or B_{UPDATE}[i] is received by the communication portion 62, that a cancellation condition is fulfilled and, if neither is received, that no cancellation condition is fulfilled. A state where an update signal A_{UPDATE} or B_{UPDATE}[i] is being received by the communication portion 62 can be understood to include a state where operation for updating the software SFT_{A} or operation for updating the software SFT_{B} in the battery unit BU[i] is actually being executed according to the update signal A_{UPDATE} or B_{UPDATE}[i].

As discussed previously in connection with the second application example, during software updating operation, the communication function should be kept active. With a configuration where reception of a signal for software updating evokes forcible switching to normal operation, it is possible to update software properly without unduly lowering the safety of the battery unit BU.

### Operation Flow

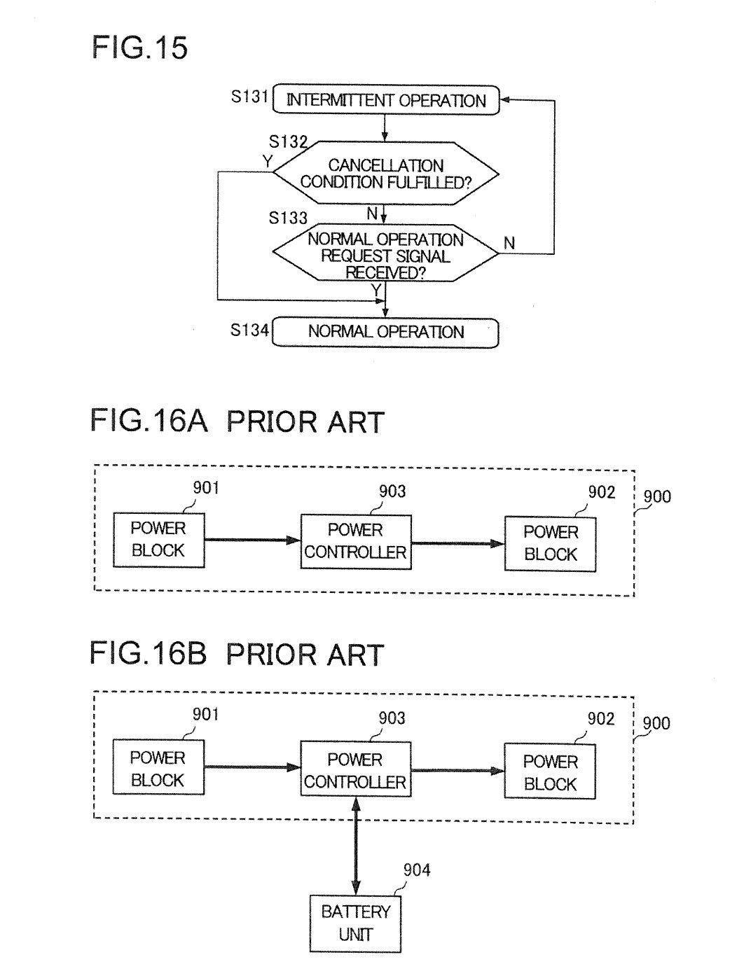

FIG. 15 is a flow chart of the operation of the battery management portion 21 in the third application example. During execution of intermittent operation (step S131), whether or not a cancellation condition is fulfilled is checked (step S132), and if a cancellation condition is fulfilled (step S132, Y), intermittent operation is stopped and normal operation is started (step S134). Even if no cancellation condition is fulfilled, whether or not a normal operation request signal REQ_{NOR} is received is checked (step S133), and if the signal REQ_{NOR} is received by the communication portion 62, switching is performed to normal operation.

In a case where the entire system including the power conversion control portion 11, the power conversion circuit 12, and the battery unit BU is designed comprehensively, the power conversion control portion 11 can control whether or not to execute intermittent operation to suit the situation at hand with a view to, for example, ensuring the safety of the battery unit BU. However, as mentioned previously, an implementation is also possible where a battery unit BU is additionally connected to an existing solar cell system or the like. In such an implementation, for example, it can occur that “the power conversion control portion 11 simply checks the current time and requests intermittent operation on the assumption that hardly any charging or discharging is performed in a midnight time zone (in reality, however, charging or discharging can be performed, and a fault such as an overdischarge fault can occur). Thus, it is sensible not to heed instructions from the power conversion control portion 11 alone in providing protection for the battery unit BU. The operation for inhibiting switching to intermittent operation in the second application example and the operation for cancelling intermittent operation in the third application example contribute to achieving such protection.

### Variations and Modifications

Embodiments of the present invention allow for many variations and modifications within the spirit and scope of the technical concepts recited in the appended claims. The embodiments described above merely present examples of how the present invention can be implemented, and the senses of the terms used to describe the present invention and its features are not limited to those in which the terms are used in the description of the embodiments. Any specific values mentioned in the above description are merely examples, and, needless to say, can be changed to many different values. As notes applicable to the embodiments described above, notes 1 to 5 are given below. Unless inconsistent, any of the notes below can be combined with any other.

### Note 1

The switch 66 can be omitted so that, when the breaker portion 22 is on, the voltage resulting discharging of the battery unit BU is supplied as the input voltage V_{IN} to the converter 63 all the time. In that case, the main control portion 62 can control the communication portions 61 and 62 such that communication operation (transmission operation and reception operation) by the communication portions 61 and 62 is stopped in sleep periods. For an enhanced power saving effect, however, it is preferable to provide the switch 66.

### Note 2

All or part of the components of the electric power system 1 (see FIG. 1) according to the embodiment can be incorporated in any of other various systems and devices. For example, they can be incorporated in a mobile body (such as an electric vehicle, ship, aircraft, elevator, or walking robot) that is driven by discharge electric power from the battery module 31, in an electronic device (such as a personal computer or portable terminal), or in an electric power system for a building or factory.

### Note 3

In the embodiment described above (see FIG. 1), it is assumed that the power block PB1 is a power block that outputs electric power and the power block PB2 is a power block that receives electric power. The power blocks PB1 and PB2 can each be a power block that can receive and output electric power. In that case, the power conversion circuit 12 can be a circuit capable of bidirectional power conversion. Specifically, the power conversion circuit 12 can have a function of converting the output electric power of the power block PB1 into input electric power to the power block PB2 or a battery block, a function of converting the output electric power of the power block PB2 into input electric power to the power block PB1 or a battery block, and a function of converting the output electric power of a battery block into input electric power to the power block PB1 or PB2.

### Note 4

A device including the battery management portion 21 and the breaker portion 22 can be referred to as a battery control device. A system including the battery management portion 21, the breaker portion 22, and the battery block BB can be referred to as a battery system. The communication portions 61 and 62 can be regarded as constituting a single communication portion for communication with the power conversion control portion 11 and each battery unit BU. A device including the power conversion control portion 11 and the power conversion circuit 12 can be referred to as a power conversion device.

### Note 5

The present invention can be applied also to an electric power system provided with a plurality of breaker portions 22 and a plurality of battery blocks BB. In that case, a single power conversion circuit 12 can be used to handle the plurality of breaker portions 22 and the plurality of battery blocks BB. In an electric power system provided with a plurality of breaker portions 22 and a plurality of battery blocks BB, one battery management portion 21 can be provided for each pair of one breaker portion 22 and one battery block BB, or one battery management portion 21 can be provided for each set of a plurality of breaker portions 22 and a plurality of battery blocks BB.

### LIST OF REFERENCE SIGNS

1 electric power system

11 power conversion control portion

12 power conversion circuit

21 battery management portion

22 breaker portion

31 battery module

60 main control portion

61, 62 communication portion

101 operation mode setting portion

BU battery unit

PB1, PB2 power block

1. A battery control device which monitors charge/discharge control, by a charge/discharge control portion, of a battery unit including a secondary battery in order to protect the battery unit, the battery control device comprising:
a communication portion which communicates with each of the battery unit and the charge/discharge control portion; and
a control portion which sets as a target operation mode either a normal operation mode in which communication is conducted continuously in the communication portion or an intermittent operation mode in which communication is suspended intermittently in the communication portion, the control portion executing communication in the communication portion according to the target operation mode,
wherein, while the target operation mode is the intermittent operation mode, when a predetermined cancellation condition is fulfilled, the control portion switches the target operation mode from the intermittent operation mode to the normal operation mode.

2. The battery control device according to claim 1, wherein
the communication portion acquires status data of the secondary battery from the battery unit, and
the control portion checks whether or not the cancellation condition is fulfilled based on the status data of the secondary battery or based on whether or not a fault is present in the battery unit or in the battery control device.

3. The battery control device according to claim 2, wherein
the status data includes at least one of a charge or discharge current value of the secondary battery, a temperature of the secondary battery, remaining capacity data indicating a remaining capacity or SOC of the secondary battery, and a terminal voltage value of the secondary battery, and
the control portion checks whether or not the cancellation condition is fulfilled based on at least one of the current value, the temperature, the remaining capacity data, and the terminal voltage value.

4. The battery control device according to claim 3, wherein
the control portion determines that the cancellation condition is fulfilled when the charge or discharge current value of the secondary battery based on the status data is larger than a predetermined threshold value.

5. The battery control device according to claim 2, wherein
the control portion determines that the cancellation condition is fulfilled when the fault is found in the battery unit or in the battery control device, and
the fault in the battery unit or in the battery control device includes at least one of a fault due to overcharging of the secondary battery, a fault due to overdischarging of the secondary battery, a fault due to an overcurrent in the secondary battery, a temperature fault in the secondary battery, a temperature fault in the battery control device, a fault in a sensor for detecting a state of the secondary battery, a fault in communication between the communication portion and the battery unit, and a fault in communication between the communication portion and the charge/discharge control portion.

6. The battery control device according to claim 1, wherein
the control portion determines that the cancellation condition is fulfilled when a signal for updating software defining operation of the battery control device, or a signal for updating software defining operation of the battery unit, transmitted from the charge/discharge control portion is received by the communication portion.

7. The battery control device according to claim 1, further comprising a communication voltage generation portion which generates a driving voltage for the communication portion based on discharge electric power from the battery unit, wherein
the intermittent operation mode includes an active period in which communication is conducted and a sleep period in which communication is stopped, and
the control portion stops communication by the communication portion by stopping supply of the discharge electric power to the communication voltage generation portion during the sleep period.

8. An electric power system comprising:
a battery unit including a secondary battery;
a power conversion device including a charge/discharge control portion which controls charging and discharging of the secondary battery, the power conversion device performing power conversion on electric power input to or output from the battery unit; and
a battery control device which monitors the charge/discharge control of the battery unit by the charge/discharge control portion in order to protect the battery unit,
wherein
the battery control device includes:
a communication portion which communicates with each of the battery unit and the charge/discharge control portion; and
a control portion which sets as a target operation mode either a normal operation mode in which communication is conducted continuously in the communication portion or an intermittent operation mode in which communication is suspended intermittently in the communication portion, the control portion executing communication in the communication portion according to the target operation mode,
wherein, while the target operation mode is the intermittent operation mode, when a predetermined cancellation condition is fulfilled, the control portion switches the target operation mode from the intermittent operation mode to the normal operation mode.
